(19) United States
(12) Patent Application Publication
(10) Pub. No.: US 2010/0061783 A1
(43) Pub. Date: Mar. 11, 2010

(54) SHEET CONVEYING APPARATUS AND IMAGE FORMING APPARATUS

(75) Inventors: Shinpei Kawasaki, Hiratsuka-shi (JP); Tadashi Matsudaira, Hachioji-shi (JP); Youbao Peng, Hino-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 12/551,743

(22) Filed: Sep. 1, 2009

(30) Foreign Application Priority Data
Sep. 9, 2008 (JP) 2008-231098

(51) Int. Cl. G03G 15/00; B65H 7/06

(52) U.S. Cl. 399/381; 271/228

(57) ABSTRACT

A sheet conveying apparatus provided with the first pair of rollers and the second pair of rollers which are positioned in the same axis perpendicular to a fixed direction, and convey a sheet in the conveying direction by rotating while nipping the sheet, the first drive section which drives the first pair of rollers and the second drive section which drives the second pair of rollers, the first detection section which detects a skew angle of the sheet against the conveying direction and a position of an edge part of the sheet in a direction perpendicular to the conveying direction before the sheet is conveyed by the pairs of rollers, and the control section which changes at least one of the rotating speeds based on the detected skew angle, and controls a timing to change the rotating speed based on the detected position of an edge part.

This application is based on Japanese Patent Application No. 2008-231098 filed on Sep. 9, 2008 in Japanese Patent Office, the entire content of which is hereby incorporated by reference.

### BACKGROUND OF THE INVENTION

The present invention relates to a sheet conveying apparatus and an image forming apparatus provided with a registration function correcting a skewed sheet conveyance.

In apparatuses, such as a copier, a printer, and a facsimile, which form an image on a transfer sheet or read an image described on a document, registration correcting a skewed sheet conveyance is conducted, with the sheet including a transfer paper immediately before image formation or a document immediately before image reading.

As the above registration method, a loop registration method, an active registration method, and a combination of both methods are known. Regarding the loop registration method, related descriptions are in, for example, Japanese Patent Application Publication (hereinafter referred to as JP-A) No. H05-338859. Regarding the active registration method, related descriptions are in, for example, JP-A No. H08-81089. And regarding a method of a combination of the above both methods, related descriptions are in, for example, JP-A No. 2002-284399.

In the loop registration method, the leading edge of a sheet strikes the nip of a pair of suspended rollers to form a loop of the sheet, and then, the skewed sheet conveyance is corrected by the elasticity of the sheet as the leading edge of the sheet is allowed to hit along the length of the nip.

In the above-described JP-A No. H05-338859, the sheet size is detected upstream of the pair of rollers, and then the loop size is controlled depending on the detected sheet size.

In the active registration method, two pairs of independently drivable registration rollers are provided on the same axis perpendicular to the sheet conveying direction, and a sensor for detecting a skew angle of the leading edge of the sheet is provided upstream of the pairs of registration rollers. The skewed sheet conveyance is corrected while a sheet, such as a transfer paper and a document, is being conveyed by controlling conveyance speeds of the two pairs of registration rollers corresponding to the skew angle of the sheet detected by the sensor. In the above-described JP-A No. H08-81089, it is disclosed that a rotational shift of a sheet material is easily performed by providing a pair of conveying rollers upstream of the pairs of registration rollers, and by providing one contact portion having a predetermined short width between the pair of conveying rollers and the sheet material at the center portion of the two pairs of registration rollers.

In the above-described JP-A No. 2002-284399, it is disclosed that the skewed sheet conveyance is corrected by selecting either the loop registration method or the active registration method in accordance with a sheet thickness or a sheet material.

On the other hand, in paragraphs [0074] to [0087] of JP-A No. 2007-22806, a transfer position correcting section is described, which is provided with a drive mechanism to rotationally shift a whole roller unit including a pair of rollers and a drive mechanism to shift a pair of rollers in the direction perpendicular to the conveying direction. In the above invention, a skewed sheet conveyance is roughly corrected by the above loop registration method, and then the skewed sheet conveyance is corrected in detail by shifting the roller unit rotationally. Further, a positional bias of a sheet is corrected by shifting the roller unit in the direction perpendicular to the sheet conveying direction.

However, the registration methods described in the above JP-A No. H05-338859, JP-A No. H08-81089, and JP-A No. 2002-284399 correct the skewed sheet conveyance, but is unable to correct a positional bias of a sheet in the direction perpendicular to the sheet conveying direction.

While the transfer position correcting section, described in the above JP-A No. 2007-22806, corrects the skewed sheet conveyance, it is also possible to correct the positional bias of a sheet. However, the mechanism is complicated, because the above transfer position correcting section is provided with a drive mechanism which performs a rotational shift and a drive mechanism which performs a parallel shift.

### SUMMARY

The present invention has been achieved in consideration of the above problems, and it is an object of the invention to provide a sheet conveying apparatus and an image forming apparatus, which can correct a skewed sheet conveyance and a positional bias of a sheet with a simple mechanism.

The characteristics of one embodiment of the present invention are summarized that the embodiment is a sheet conveying apparatus and an image forming apparatus which are provided with the first pair of rollers and the second pair of rollers which are provided in the same axis perpendicular to a fixed direction, and convey a sheet in the fixed direction by rotating while nipping the sheet, the first drive section which drives the first pair of rollers, the second drive section which drives the second pair of rollers, the first detection section which detects a skew angle of the sheet with respect to the fixed direction before the sheet is conveyed by the first pair of rollers and the second pair of rollers and a position of an edge part of the sheet in a direction perpendicular to the fixed direction, a speed control section which makes rotating speeds differ between the first pair of rollers and the second pair of rollers based on the skew angle detected by the first detection section, and a timing control section which controls a timing when the speed control section starts to make speed differ based on the position of the edge part detected by the first detection section.

Here, the term a “sheet” includes a transfer sheet and a document used in an apparatus which forms an image on the transfer sheet, or in an apparatus which reads an image printed on the document, and the apparatus includes a copier, a printer, or a facsimile.

### BRIEF DESCRIPTION OF THE DRAWINGS

FIG. 1 is a front view which gives an outline of an internal constitution of the color copier 100 according to an embodiment of the present invention.

FIG. 2 is a schematic diagram explaining the rough constitution of the conveyance section 20 which corrects a skewed sheet conveyance and a positional bias of a sheet P, which take place at a conveyance path.

FIG. 3 is a flow chart indicating procedures in which the conveyance section 20 shown in FIG. 2 corrects a skewed sheet conveyance and a positional bias of a sheet, which take place at a conveyance path.

FIG. 4 is a schematic diagram showing that the conveyance section 20 shown in FIG. 2 corrects a skewed sheet conveyance and a positional bias of a sheet.

Each of FIG. 5a and 5b is a schematic diagram explaining a relation between an amount of the bias ΔA of a sheet detected by the first detection section 23M and the timing of starting to control the speed difference, and FIG. 5a shows the timing of starting a control in the case where the amount of the bias ΔA is relatively small, and FIG. 5b shows the timing of starting a control in the case where the amount of the bias ΔA is relatively large.

FIG. 6a to FIG. 6c are schematic diagrams showing various combinations of an amount of the bias ΔA and a skew angle θ of a sheet detected by the first detection section 23M.

FIG. 7 is a table summarizing a relationship between various combinations of the amount of the bias ΔA and the skew angle θ shown in FIG. 6, and the timing of starting to control the speed difference in the above combinations.

FIG. 8 is a schematic diagram explaining an example of a method that the control section 15 calculates the speed difference ΔV between the first pair of rollers 23A and the second pair of rollers 23B, and a timing T of starting a control of the speed difference.

### DETAILED DESCRIPTION OF THE PREFERRED EMBODIMENTS

According to the characteristics of one of the embodiments of the above-described present invention, since the first drive section and the second drive section independently drive the first pair of rollers and the second pair of rollers respectively, the speed control section can control the rotating speeds of the first pair of rollers and the second pair of rollers individually. By making the rotating speed differ between the first pair of rollers and the second pair of rollers while the above pairs of rollers nip a sheet, the first pair of rollers and the second pair of rollers can change an orientation of a sheet at the same time while conveying the sheet. Therefore, the control section can shift a sheet orientation to the predetermined reference orientation by making rotating speed differ between the first pair of rollers and the second pair of rollers based on the skew angle detected by the first detection section.

When the timing when the control section starts to make speed differ is relatively early, the rear part of the sheet largely shifts in a direction perpendicular to a fixed direction. And when the timing when the control section starts to make speed differ is relatively late, the front part of the sheet largely shifts in a direction perpendicular to the fixed direction. Therefore, the timing control section can shift the position of the edge part of the sheet to the predetermined target position by controlling the timing when the control section starts to make speed differ based on the position of the edge part of the sheet detected by the first detection section.

Further, since it will do well only if the first drive section and the second drive section are provided with a mechanism which drives the first pair of rollers and the second pair of rollers independently, an orientation of a sheet and a position of an edge part of the sheet can be adjusted by a relatively simple mechanism.

Therefore, according to the characteristics of one of the embodiments of the present invention, there can be provided a sheet conveying apparatus and an image forming apparatus, which can correct a skewed sheet conveyance and a positional bias of a sheet with a simple mechanism.

In the characteristics of one of the embodiments of the present invention, the sheet conveying apparatus may further be provided with the second detection section which detects a position of an edge part of the aforesaid sheet in the direction perpendicular to a fixed direction before the skew angle and the position of an edge part are detected by the first detection section, and the timing control section may control a timing when the speed control section starts to make speed differ using the position of the edge part detected by the above second detection section as a targeted position. With this system, since the timing control section can adjust the position of the edge part of the sheet to the position of the edge part of the sheet detected by the second detection section, it is possible to set a target position for each sheet when a positional bias of a sheet is corrected.

Alternatively, the timing control section may control a timing when the speed control section starts to make speed differ using the predetermined position as a targeted position. With this method, since the timing control section can shift the position of the edge part to the predetermined target position, it is possible to standardize the position of the edge part of a sheet after the positional bias of the sheet was corrected.

Referring to the drawings, as an example of an image forming apparatus provided with the sheet conveying apparatus according to an embodiment of the present invention, a color copier is described below. In the description of the drawings, the same elements will have the same symbols, and their descriptions will be omitted.

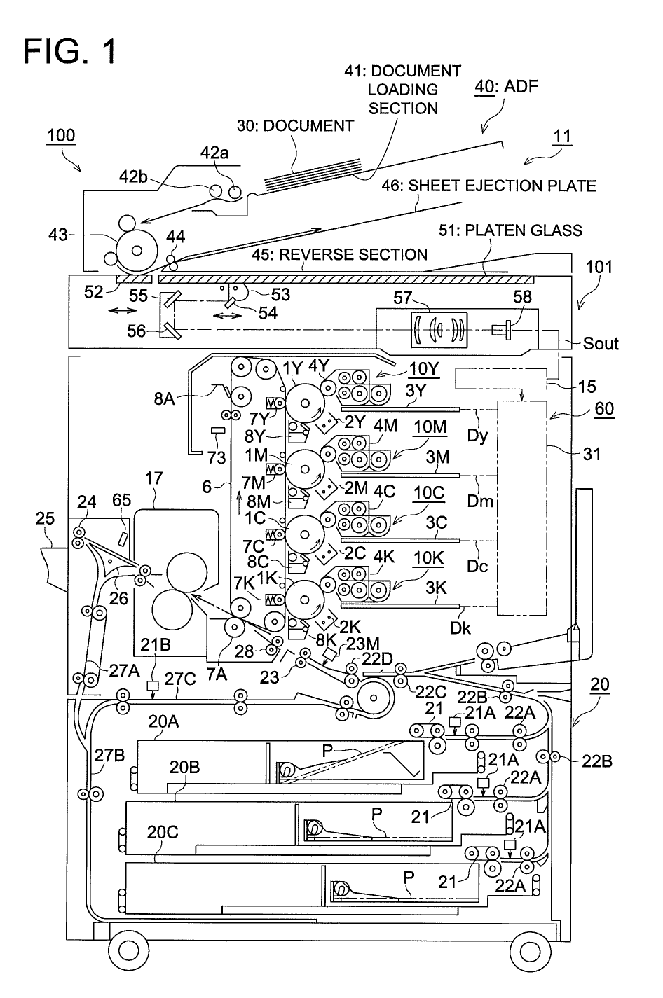

First, while referring to FIG. 1, the outline of the internal constitution of the color copier 100 according to an embodiment of the present invention will be described. The color copier 100 is an apparatus, which obtains image information by reading a color image formed on a document 30, and then, based on the above image information, each color image is formed onto a photoreceptor drum. Consequently an image which is composed of the superimposed colors is formed on a sheet in the apparatus.

The color copier 100 has the copier body 101. On the upper part of the copier body 101, an image input section 11 and an ADF 40 are provided. The term “ADF” is an abbreviation of an “automatic document feeder”. In the ADF mode, the ADF 40 operates so that it automatically feeds one or a plurality of documents 30. The term “ADF model” is an abbreviation of an “automatic document feeder mode”, and means an operation which automatically feeds the document 30 placed on the ADF 40, and automatically reads out an image on the document.

The ADF 40 is composed of a document loading section 41, a roller 42a, a roller 42b, a roller 43, a conveying roller 44, and a sheet ejection plate 46. On the document loading section 41, one or a plurality of documents 30 are placed. In the downstream of the document loading section 41, the roller 42a, and the roller 42b are provided. When the ADF mode is selected, the document 30 sent out from the document loading section 41 is conveyed by the roller 43 located downstream so that the document 30 rotates in a horseshoe shape. In the case where the ADF mode is selected, the document 30 is placed on the document loading section 41 with the recording surface thereof facing up.

The image input section 11 operates so that it reads out a color image formed on the document 30. In the image input section 11, for example, a slit scan type color scanner is employed. In the image input section 11, an image sensor 58, which is arranged in an array shape, is provided, and is allowed to read the surface of the document 30 to output an image reading signal Sout, in the ADF mode for example, when the document 30 is reversed in a horseshoe shape by the roller 43. For the image sensor 58, for example, an imager composed, for example, of a three-line color CCD is employed. The term “CCD” is an abbreviation of a “charge-coupled device”.

The image sensor 58 is provided with three reading out sensors for the red, green, and blue light detection, the sensors of which are composed of a line of a plurality of light receiving elements being arranged in the main scanning direction, and the three reading out sensors partition pixels at different positions in the sub-scanning direction perpendicular to the main scanning direction, and read out information of the red, green, and blue light at the same time.

The document 30, whose information was read out at the image input section 11, is conveyed by the conveying roller 44 and ejected to the sheet ejection plate 46. Further, the image sensor 58 is, in a platen mode, allowed to output image reading signals of the RGB color system, which signals were obtained by reading out the document 30. The term “platen mode” means an operation to automatically read out a document image by scanning the document 30 placed on a platen glass with an optical driving system.

The image input section 11 is composed, in addition to the image sensor 58, of a first platen glass 51, a second platen glass 52, a light source 53, a mirror 54, a mirror 55, a mirror 56, an imaging optical section 57, and an optical driving section not particularly illustrated. The second platen glass 52 contains an ADF glass. The light source 53 irradiates the document 30 with light. The optical driving section operates so as to shifts the document 30 or the image sensor 58 relatively with each other in the sub-scanning direction. The term “sub-scanning direction” means a direction perpendicular to a main scanning direction, provided that an arrangement direction of a plurality of light receiving elements constituting the image sensor 58 is designated as the main scanning direction. The mirrors 54 to 56 are arranged so as to sent back the light reflected on the document 30, and the imaging optical section 57 makes the reflected light form an image at the image sensor 58. As described above, the document 30, which is placed on the document loading section 41 of the ADF 40, is conveyed by the above-described rollers 42a, 42b, 43, and the conveying roller 44; images on one side or both sides of the document 30 are scanning-exposed by the optical system of the image input section 11 containing the light source 53, the mirrors 54, 55, and 56, the imaging optical section 57, and the optical driving section; and the reflected light including the image information of the document 30 is read by the image sensor 58.

The image sensor 58 converts the amount of incident light into the amount of electric charge. Analog image reading signals converted photoelectrically is subjected to an A/D conversion in the image input section 11, and digital image reading signals Sout are outputted from the image input section 11. To the image input section 11, an image processing section 31 is connected through a control section 15. The image processing section 31 converts digital image reading signals Sout into image data of each component of red, green, and blue by conducting processing such as image compression and magnification change. Further, the image processing section 31 converts image data of each component of red, green, and blue into image data Dy, Dm, Dc, and Dk for yellow, magenta, cyan, and black via a three-dimensional color information conversion table. The converted image data Dy, Dm, Dc, and Dk are transferred to exposure sections 3Y, 3M, 3C and 3K, which constitutes an image forming section 60, respectively.

The copier body 101 is called as a tandem type color image forming apparatus. The copier body 101 is provided with the image forming section 60. The image forming section 60 forms color images based on the image data Dy, Dm, Dc, and Dk, which were read out by the image input section 11. The image forming section 60 is provided with a plurality of image forming units 10Y, 10M, 10C, and 10K having photoreceptor drums for each colors of yellow, magenta, cyan, and black, an endless belt-type intermediate transfer body 6, and a fixing apparatus 17 for fixing a toner image which was transferred onto a sheet from the intermediate transfer body 6.

The image forming unit 10Y which forms yellow images includes a photoreceptor drum 1Y which forms yellow toner images, and a charger 2Y, an exposure unit 3Y, a developing device 4Y, and a cleaning unit 8Y for image forming body, all of which are used for yellow images and arranged around the photoreceptor drum 1Y. The image forming unit 10M which forms magenta images includes a photoreceptor drum 1M which forms magenta toner images, and a charger 2M, an exposure unit 3M, a developing device 4M, and a cleaning unit 8M for image forming body, all of which are used for magenta images.

The image forming unit 10C which forms cyan images includes a photoreceptor drum 1C which forms cyan toner images, and a charger 2C, an exposure unit 3C, a developing device 4C, and a cleaning unit 8C for image forming body, all of which are used for cyan images. The image forming unit 10K which forms black images includes a photoreceptor drum 1K which forms black toner images, and a charger 2K, an exposure unit 3K, a developing device 4K, and a cleaning unit 8K for image forming body, all of which are used for black images.

Each of the photoreceptor drums 1Y, 1M, 1C, and 1K is a cylindrical body rotating around the predetermined axis which is perpendicular to the conveying direction of a sheet on which color images are formed. The chargers 2Y, 2M, 2C, and 2K electrify the sides of the photoreceptor drums 1Y, 1M, 1C, and 1K by successively and uniformly supplying charges to the sides of the rotating photoreceptor drums 1Y, 1M, 1C, and 1K.

Each of the exposure units 3Y, 3M, 3C, and 3K is provided with a plurality of light modulation devices which are linearly arranged in a main scanning direction which is parallel to the above-described predetermined axis. For example, each of the exposure units 3Y, 3M, 3C, and 3K can use an LPH in which an LED element is used as the light modulation device. The term “LPH” is an abbreviation of a LED print head. Each of the light modulation devices irradiates each side of the photoreceptor drums 1Y, 1M, 1C, and 1K with light. Each of the exposure units 3Y, 3M, 3C, and 3K modulates light emitted to each side of the rotating photoreceptor drums 1Y, 1M, 1C, and 1K based on image data Dy, Dm, Dc, Dk. Thus, by linear light intermittently emitted, which is parallel to the predetermined axis, to each side of the rotating photoreceptor drums 1Y, 1M, 1C, and 1K, an electrostatic latent image is formed on each of the photoreceptor drums 1Y, 1M, 1C, and 1K. This is referred to as an “exposure”.

Each of the developing devices 4Y, 4M, 4C, and 4K develops the electrostatic latent image formed on each of the photoreceptor drums 1Y, 1M, 1C, and 1K, to form each of toner images of yellow, magenta, cyan, and black. This is referred to as a “development”. The development at each of the developing devices 4Y, 4M, 4C, and 4K is carried out by a reverse development, in which a development bias having the same polarity as the toners is applied such as an AC voltage superimposed on a negative polar DC voltage.

The intermediate transfer body 6 is supported in a rotatable manner by a plurality of rollers. Each of primary transfer rollers 7Y, 7M, 7C, and 7K is provided at a position facing to each of the photoreceptor drums 1Y, 1M, 1C, and 1K respectively, while each of the above primary transfer rollers and each of the above photoreceptor drums nips the intermediate transfer body 6. By applying the primary transfer bias having an opposite polarity to the toners employed, for example, a positive polar bias, to the primary transfer rollers 7Y, 7M, 7C, and 7K, each of the toner images of yellow, magenta, cyan, and black formed on each of the photoreceptor drums 1Y, 1M, 1C, and 1K is successively transferred on the rotating intermediate transfer body 6 with the toner images being superimposed. In this way, a color image, in which each of toner images of yellow, magenta, cyan, and black is superimposed, is formed on the intermediate transfer body 6. This is referred to as a “primary transfer”.

In a lower part of the image forming section 60, the conveyance section 20, which operates so as to convey a sheet P to the image forming section 60, is provided. The sheet conveying apparatus according to an embodiment of the present invention can be applied to the above conveyance section 20. The conveyance section 20 contains paper feed trays 20A, 20B, and 20C, and a plurality of pairs of rollers 21, 22A, 22B, 22C, 22D, 23, and 28, which convey a sheet to the fixed direction by rotation while nipping the sheet P. The sheet P, housed in the paper feed trays such as the paper feed tray 20A, is fed by the pair of delivery rollers 21 and the pair of paper feed rollers 22A, and is conveyed to a pair of secondary transfer rollers 7A, through the pairs of conveying rollers 22B, 22C, 22D, and 23, and the pair of registration rollers 28, whereby the color toner images are collectively transferred from the intermediate transfer body 6 onto one side of the sheet P, for example, on the front side of the sheet P. This is referred to as a “secondary transfer”.

The fixing apparatus 17 melts and fixes toners onto the sheet P by applying heat and pressure to the sheet P on which the color toner image has been transferred. This is referred to as a “fixing processing”. The sheet P having been subjected to the fixing processing is nipped by a pair of sheet discharge rollers 24, and then placed on a sheet discharge tray 25 disposed outside the apparatus main body. Toners remained on the periphery of each of the photoreceptor drums 1Y, 1M, 1C, and 1K after the transfer are removed by the cleaning sections 8Y, 8M, 8C, and 8K to enter the following color image forming cycle.

In a double-sided image formation on the sheet P, after an image is formed on the front surface, the sheet P ejected from the fixing apparatus 17 is branched away from the sheet ejecting path via a branching section 26. Subsequently, the sheet P passes through a circulating sheet path 27A, which is located downward, and the front and back surfaces of the sheet P are reversed by a reversing conveying path 27B which is a re-sheet feeding mechanism, and then the sheet P passes through a re-sheet feeding section 27C, and passes through the pair of conveying rollers 22D to join the above-described transfer path.

The sheet, having been reversed and conveyed, is again conveyed to the secondary transfer roller 7A through the pair of registration rollers 28, and then an color toner image is collectively transferred onto the back surface of the sheet P. After the color toner image was transferred to the sheet P by the secondary transfer roller 7A, the toners remained on the intermediate transfer body 6 from which the sheet P has been separated due to a curvature, are removed by the cleaning section 8A for the intermediate transfer body.

The color copier 100 is provided with, in addition to the copier body 101, a post-processing apparatus and a high-capacity sheet feeder (not illustrated in FIG. 1), which are disposed adjacent to the copier body 101. The post-processing apparatus carries out processes such as large-volume sheet stacking, sorting, stapling, hole-punching, sheet folding, cover sheet inserting, simple bookbinding, and cutting; and the high-capacity sheet feeder feeds a large quantity of sheets.

As described above, the conveyance section 20 conveys the sheet P in the fixed direction on the conveyance path from the paper feed trays 20A, 20B, and 20C to the pair of secondary transfer rollers 7A; and on the conveyance path from the pair of secondary transfer rollers 7A back again to the pair of secondary transfer rollers 7A passing through the branching section 26, the circulating sheet path 27A, the reversing conveying path 27B, and the re-sheet feeding section 27C. The term “in the fixed direction” corresponds to the conveying direction of the sheet P.

The conveyance section 20 is further provided with the first detection section 23M, which is disposed on the conveying path upstream of a pair of correction rollers 23, and the second detection sections 21A and 21B, which is disposed on the conveying path upstream of the first detection section 23M. Since the first detection section 23M aims to detect the skewed sheet conveyance and the positional bias of the sheet P at a time when the sheet P is conveyed to the pair of correction rollers 23, the first detection section 23M is disposed upstream of the pair of correction rollers 23. In the example of FIG. 1, the above first detection section 23M is disposed between the pair of correction rollers 23 and the pairs of conveying rollers 22C and 22D.

Since the second detection sections 21A and 21B aim to detect a target position to be used at a time when the positional bias of the sheet P taking place on the conveyance path is corrected, the second detection sections 21A and 21B are disposed upstream of the first detection section 23M. In the example of FIG. 1, the second detection section 21A is disposed between the pair of delivery rollers 21 and the pair of paper feed rollers 22A, and the second detection section 21B is disposed on the re-sheet feeding section 27C on the side of the reversing conveying path 27B. The dispositions of the first detection section 23M and the second detection sections 21A and 21B, which are shown in FIG. 1, are just an example, and they can be disposed at other positions.

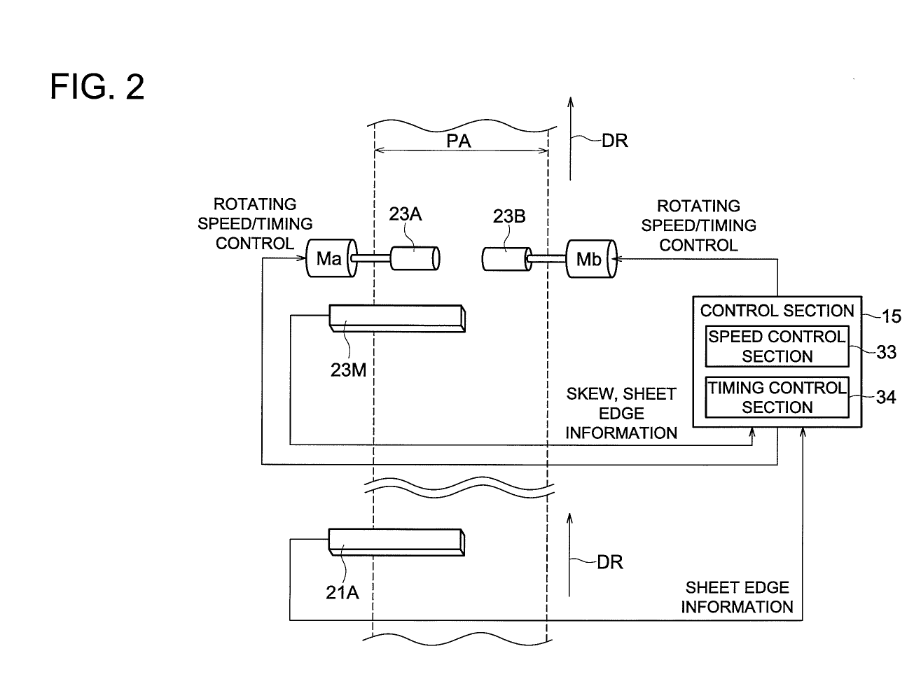

Next, the constitution and the motion of the conveyance section 20 correcting the skewed sheet conveyance and the positional bias of the sheet P is described. As shown in FIG. 2, the conveyance section 20 is, as the pair of correction rollers 23 in FIG. 23, provided with the first pair of rollers 23A and the second pair of rollers 23B, both of which are disposed in the same axis perpendicular to the conveying direction DR. The first pair of rollers 23A is connected with the first drive section Ma composed of a motor and others through a rotating shaft, and second pair of rollers 23B is connected with the second drive section Mb composed of a motor and others through a rotating shaft. The first drive section Ma transmits rotational power to the first pair of rollers 23A through a rotating shaft to rotate the first pair of rollers 23A. The second drive section Mb transmits rotational power to the second pair of rollers 23B through a rotating shaft to rotate the second pair of rollers 23B. As described above, the first pair of rollers 23A and the second pair of rollers 23B are independently driven by the first drive section Ma and the second drive section Mb, respectively.

Each of the first detection section 23M and the second detection section 21A is provided with, for example, a line sensor in which a plurality of image sensors are linearly arranged in the direction perpendicular to the conveying direction DR. In the line sensor, the sensitivity region of the line sensor is formed to extend over one edge part of the range P_{A} in which a sheet passes. In the example of FIG. 2, the sensitivity region of the line sensor is formed to extend the left edge part when seeing in the conveying direction.

The first detection section 23M detects a skew angle with respect to the conveying direction DR of a sheet, and a position of an edge part of the sheet in the direction perpendicular to the conveying direction DR, before the sheet arrives at the first pair of rollers 23A and the second pair of rollers 23B. The second detection section 21A detects a position of an edge part of the sheet in the direction perpendicular to the conveying direction DR, before the skew angle and the position of an edge part are detected by the first detection section 23M. In the example of FIG. 2, the first detection section 23M and the second detection section 21A detect the position of the left edge part when seeing in the conveying direction DR.

The control section 15 changes at least one of rotating speeds of the first pair of rollers 23A and the second pair of rollers 23B based on the skew angle detected by the first detection section 23M, and at the same time controls a timing of changing the rotating speed based on the position of an edge part of the sheet detected by the first detection section 23M. The control section 15 controls a timing when the speed control section 33 starts to make speed differ with the position of an edge part of the sheet detected by the second detection section 21A being a target position.

Specifically, the control section 15 receives data signals indicating the skew angle and the position of the edge part from the first detection section 23M, and then changes at least one of the rotating speeds of the first drive section Ma and the second drive section Mb. Based on the above change, the control section 15 can correct the skewed sheet conveyance detected by the first detection section 23M. The term “skewed sheet conveyance” means that a sheet is conveyed while being skewed with respect to the conveying direction DR.

The control section 15 receives data signals indicating the position of the edge part of a sheet from the second detection section 21A, and data signals indicating the skew angle and the position of the edge part from the first detection section 23M, and then controls a timing to change at least one of the rotating speeds of the first drive section Ma and the second drive section Mb. Based on the above control, the control section 15 can correct a positional bias of a sheet which was detected by the first detection section 23M. The term a “positional bias” means that a position of a sheet in the direction perpendicular to the conveying direction DR is deviated from a predetermined target position.

Though, the second detection section 21A was described in FIG. 2, the second detection section 21B is also provided with the similar constitution and functions to the second detection section 21A.

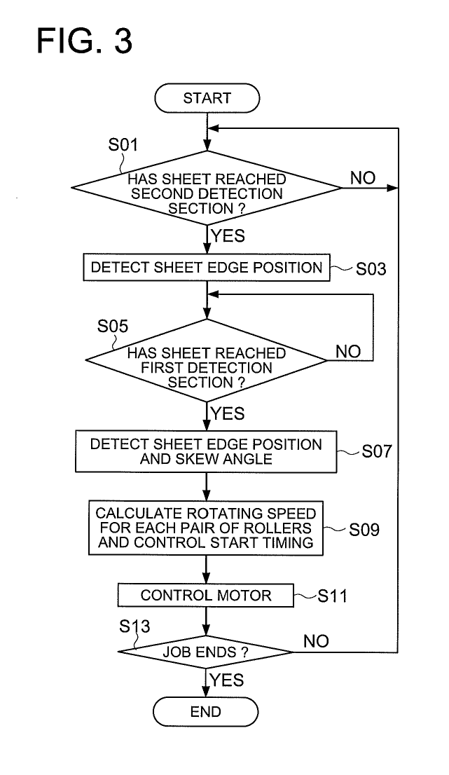

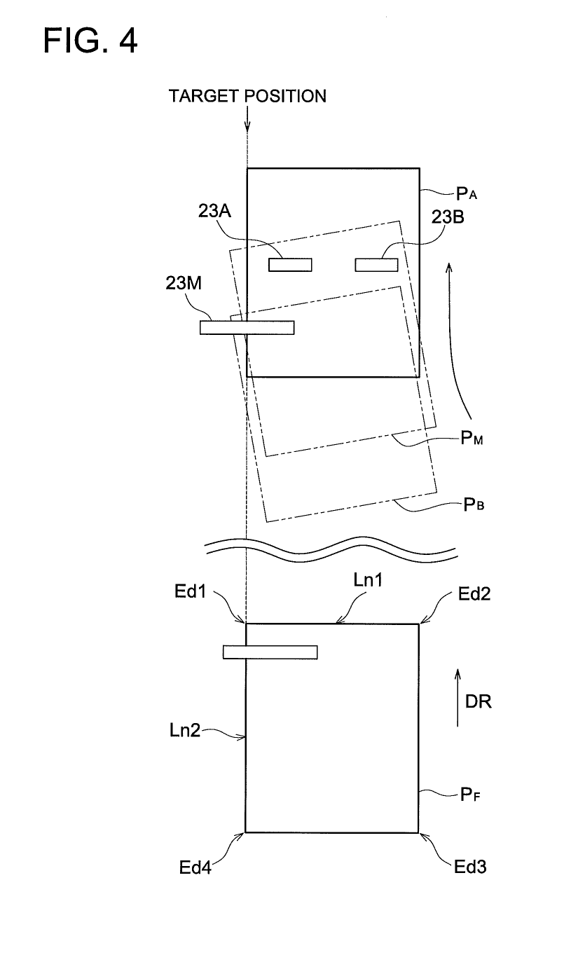

Referring to FIGS. 3 and 4, steps for correcting the skewed sheet conveyance and the positional bias of a sheet caused on the conveyance path of the conveyance section 20, will be described.

(a) First, in step S01, it is awaited that a sheet reaches the second detection section 21A. If the sheet reaches the second detection section 21A (YES in step S01), the process proceeds to step S03, and the second detection section 21A detects a position of an edge part of the sheet in the direction perpendicular to the conveying direction DR. Specifically, as shown in FIG. 4, the second detection section 21A detects the position of the corner part Ed1 of the sheet P_{F} which was fed from the paper feed trays 20A, 20B, or 20C (not illustrated) in the direction perpendicular to the conveying direction DR, and sends the data signals of the detected position of the corner part Ed1 to the control section 15.

(b) Proceeding to step S05, it is awaited that the above sheet reaches the first detection section 23M. If the sheet reaches the first detection section 23M (YES in step S05), the process proceeds to step S07, and the first detection section 23M detects a skew angle of a sheet with respect to the conveying direction DR, and a position of an edge part of the sheet in the direction perpendicular to the conveying direction DR. Specifically, as shown in FIG. 4, the first detection section 23M detects a skew angle of a sheet P_{B} with respect to the conveying direction DR and the position of the corner part Ed1 of the sheet P_{B} in the direction perpendicular to the conveying direction DR, before it is conveyed by the first pair of rollers 23A and the second pair of rollers 23B, and then sends the data signals of the detected skew angle and position of the corner part Ed1 to the control section 15.

(c) Proceeding to step S09, the control section 15 calculates the difference of the rotating speeds between the first pair of rollers 23A and the second pair of rollers 23B, based on the skew angle detected by the first detection section 23M. Then, the control section 15 calculates a timing to change the rotating speed based on the position of the corner edge Ed1 of the sheet P_{F} detected by the second detection section 21A, the position of the corner part Ed1 of the sheet P_{B} detected by the first detection section 23M, and the calculated difference of the rotating speeds.

(d) Proceeding to step S11, the control section 15 makes the rotating speeds differ between the first drive section Ma and the second drive section Mb based on the calculated difference of the rotating speeds. At the same time, the control section 15 controls the above-mentioned timing to change the rotating speed based on the calculated control start timing. Specifically, as shown in FIG. 4, the control section 15 changes at least one of the rotating speeds, based on the calculated difference of the rotating speeds, of the first pair of rollers 23A and the second pair of rollers 23B for the sheet P_{M} to which the calculated control start timing has come.

(e) In the example of FIG. 4, since the sheet P_{B} is skewed in the counterclockwise direction, the rotating speed of the first pair of rollers 23A is increased to be faster than that of the second pair of rollers 23B, or the rotating speed of the second pair of rollers 23B is decreased to be slower than that of the first pair of rollers 23A. With this method, the sheet P_{M} starts to rotate in the clockwise direction. The control section 15 continues the above control of the speed difference until the sheet becomes the state of the sheet P_{A} shown in FIG. 4, that is, the state in which the skewed sheet conveyance and the positional bias of the sheet detected by the first detection section 23M were corrected. After the correction, the control section 15 changes the rotating speed to rotate the first pair of rollers 23A and the second pair of rollers 23B at the same speed. As described above, by controlling a timing to start the control of the speed difference, the skewed sheet conveyance and the positional bias of the sheet detected by the first detection section 23M can be simultaneously corrected.

(f) Lastly, proceeding to step S13, the control section 15 judges if the job which the color copier 100 received, has been finished or not. If the job has not been finished (NO in step S13), returning to step S01, the above-described steps are repeated. If the job has been finished (YES in step S13), the process of the flow chart shown in FIG. 3 is finished.

Next, with referring to FIGS. 5a and 5b, the relation between an amount of the bias ΔA of the sheet P_{M} detected by the first detection section 23M and a timing to start control of speed difference is described. As shown in FIG. 5a, in the case where the amount of the bias ΔA of the sheet P_{M} is relatively small, the control of speed difference starts during the leading portion of the sheet P_{M} is nipped by both the first pair of rollers 23A and the second pair of rollers 23B. On the other hand, as shown in FIG. 5b, in the case where the amount of the bias ΔA of the sheet P_{M} is relatively large, the control of speed difference starts during the trailing portion of the sheet P_{M} is nipped by both the first pair of rollers 23A and the second pair of rollers 23B. Here, in FIGS. 5a and 5b, both skew angles of the sheet P_{M} are the same. The term “target position” in FIG. 5 corresponds to the position of the corner part Ed1 of the sheet P_{F} detected by the second detection section 21A. The term “amount of the bias ΔA” is a distance in the direction perpendicular to the conveying direction DR from the target position to the corner edge Ed1 of the sheet P_{B} detected by the first detection section 23M.

The rotational shift of the sheet P_{M} by the control of the speed difference is performed keeping a point on the axis of the first pair of rollers 23A and the second pair of rollers 23B or the vicinity of the point to be a center of the rotation. Therefore, even if the rotation angles of the sheet P_{M} are the same, when the timing to start control of the speed difference is early as shown in FIG. 5a, the shift distance of the corner part Ed1 of the sheet P_{M} becomes short. On the other hand, when the timing to start control of the speed difference is late as shown in FIG. 5b, the shift distance of the corner part Ed1 of the sheet P_{M} becomes long. Then, by controlling the timing to start control of the speed difference in response to the amount of the bias ΔA of the sheet P_{M}, it becomes possible to also correct the positional bias of the sheet P_{M}, at the same time of correcting the skewed sheet conveyance of the sheet P_{M}.

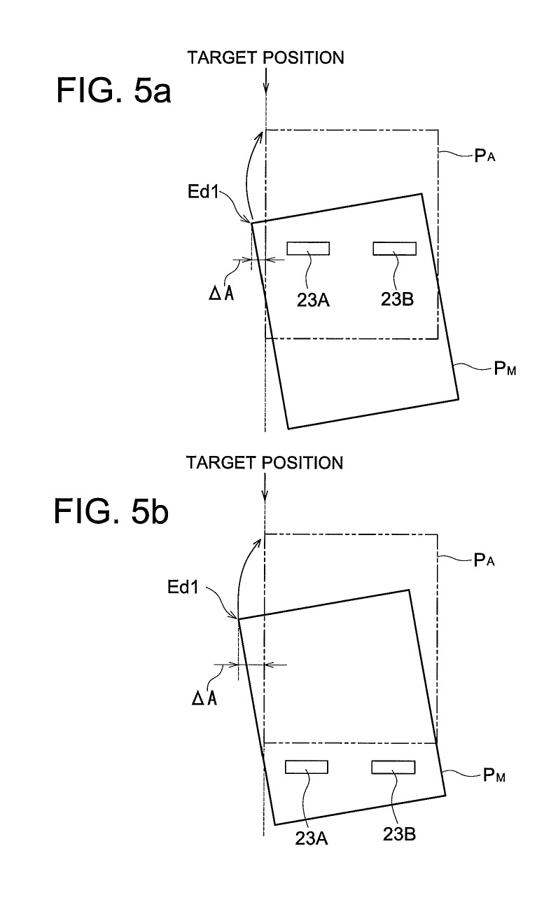

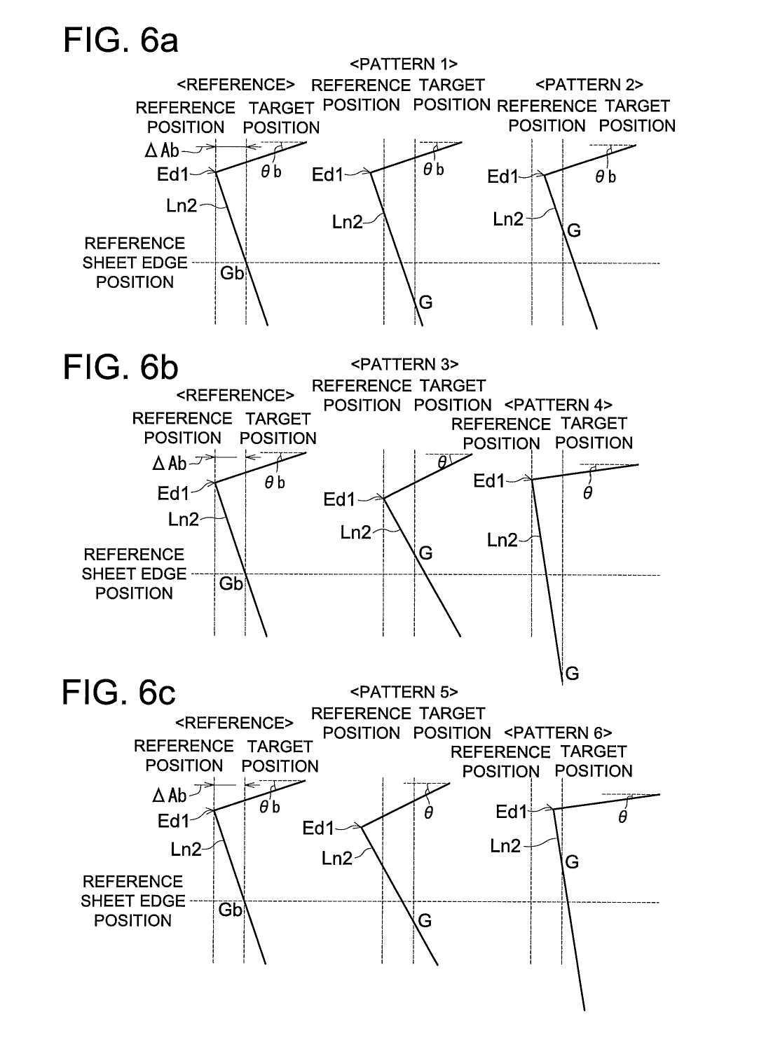

Referring to FIGS. 6a to 6c, various combinations of the amount of the bias ΔA and the skew angle θ of a sheet detected by the first detection section 23M will be described.

The “reference” of FIG. 6a indicates a case where the reference amount of the bias ΔAb and the reference skew angle θb are detected by the first detection section 23M. In this case, a point on the side Ln2 of a sheet which crosses the target position is referred to as the reference sheet edge position Gb.

The “pattern 1” of FIG. 6a

indicates a case where the amount of the bias ΔA detected by the first detection section 23M is larger than the reference amount of the bias ΔAb, and the skew angle θ is equal to the reference skew angle θb. In this case, the point on the side Ln2 of a sheet which crosses the reference position is located posterior to the reference sheet edge position Gb. Thereafter, the point on the side Ln2 of a sheet which crosses the reference position is referred to as the sheet edge position G. The “pattern 2” of FIG. 6a indicates a case where the amount of the bias ΔA detected by the first detection section 23M is smaller than the reference amount of bias ΔAb, and the skew angle θ is equal to the reference skew angle θb. In this case, the sheet edge position G is located anterior to the reference sheet edge position Gb.

The “pattern 3” of FIG. 6b indicates a case where the amount of the bias ΔA detected by the first detection section 23M is equal to the reference amount of the bias ΔAb, and the skew angle θ is larger than the reference skew angle θb. In this case, the sheet edge position G is located anterior to the reference sheet edge position Gb. The “pattern 4” of FIG. 6b indicates a case where the amount of the bias ΔA detected by the first detection section 23M is equal to the reference amount of the bias ΔAb, and the skew angle θ is smaller to the reference skew angle θb. In this case, the sheet edge position G is located posterior to the reference sheet edge position Gb.

The “pattern 5” of FIG. 6c indicates a case where the amount of the bias ΔA detected by the first detection section 23M is larger than the reference amount of the bias ΔAb, and the skew angle θ is larger than the reference skew angle θb. In this case, the positional relationship is not simply defined but varies depending on relations between the detected amount of the bias ΔA and the skew angle θ. The “pattern 6” of FIG. 6c indicates a case where the amount of the bias ΔA detected by the first detection section 23M is smaller than the reference amount of the bias ΔAb, and the skew angle θ is smaller than the reference skew angle θb. In this case, the positional relationship between the sheet edge position G and the reference sheet edge position Gb is also not simply defined but varies depending on relations between the detected amount of the bias ΔA and the skew angle θ.

In the “pattern 2” of FIG. 6a and the “pattern 3” of FIG. 6b, since the sheet edge position G is located anterior to the reference sheet edge position Gb, the shift distance of the corner edge Ed1 of the sheet P_{M} is shortened by making a timing to start controlling a speed difference earlier as shown in FIG. 5a. Further, the speed difference in the “pattern 3” of FIG. 6b is made larger than that in the “reference”.

In the “pattern 5” and the “pattern 6” of FIG. 6c, since the positional relationship between the sheet edge position G and the reference sheet edge position Gb is not simply defined, the timing to start controlling the speed difference also varies depending on detected amount of the bias ΔA and the skew angle θ.

As patterns not shown in FIG. 6, there are cases where the amount of the bias ΔA detected by the first detection section 23M is smaller than the reference amount of the bias ΔAb, and the skew angle θ is larger than the reference skew angle θb, and where the amount of the bias ΔA detected by the first detection section 23M is larger than the reference amount of the bias ΔAb, and the skew angle θ is smaller than the reference skew angle θb. In the former case, since the sheet edge position G is located anterior to the reference sheet edge position Gb, the shift distance of the corner edge Ed1 of the sheet P_{M} is shortened by making a timing to start controlling a speed difference earlier as shown in FIG. 5a. In the later case, since the sheet edge position G is located posterior to the reference sheet edge position Gb, the shift distance of the corner edge Ed1 of the sheet P_{M} is lengthened by making a timing to start controlling a speed difference later as shown in FIG. 5b.

As described above, depending on the sheet edge position G being located anterior or posterior to the reference sheet edge position Gb, it is possible to determine whether the timing to start controlling a speed difference is earlier or later than the reference timing.

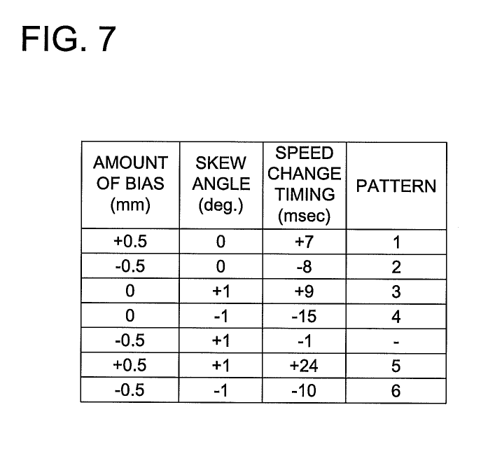

In the table of FIG. 7, using specific numerical values, a relationship between timings to start controlling a speed difference and combinations of various amounts of the bias ΔAb and skew angles θ is summarized. In FIG. 7, the “amount of bias (mm)” indicates an amount of the bias with respect to the reference position in FIG. 6 with the direction moving away from the target position being a positive value. The “skew angle (degree)” indicates a skew angle with respect to the reference skew angle θb in FIG. 6. The “speed change timing (msec)” indicates a timing to change the rotation speed of the roller 23A and the roller 23B. The “pattern” indicates the pattern number in FIG. 6. The example of FIG. 7 indicates a case where the reference amount of the bias ΔAb, the reference skew angle θb, and the reference time of control timing are set to be 1 mm, 5 degrees, and 212 msec, respectively. The term “reference time of control timing” indicates a time from when a leading edge of a sheet reaches a pair of correction rollers until when a center of the sheet reaches the pair of correction rollers.

As shown in FIG. 7, as an example of the “pattern 1” of FIG. 6a, in the case where the amount of the bias is +0.5, and the skew angle is zero, the speed change timing becomes +7. As an example of the “pattern 2” of FIG. 6a, in the case where the amount of the bias is −0.5, and the skew angle is zero, the speed change timing becomes −8.

As an example of the “pattern 3” of FIG. 6b, in the case where the amount of the bias is zero, and the skew angle is +1, the speed change timing becomes +9. As an example of the “pattern 4” of FIG. 6b, in the case where the amount of the bias is zero, and the skew angle is −1, the speed change timing becomes −15.

As an example of the “pattern 5” of FIG. 6c, in the case where the amount of the bias is +0.5, and the skew angle is +1, the speed change timing becomes +24. As an example of the “pattern 6” of FIG. 6c, in the case where the amount of the bias is −0.5, and the skew angle is −1, the speed change timing becomes −10.

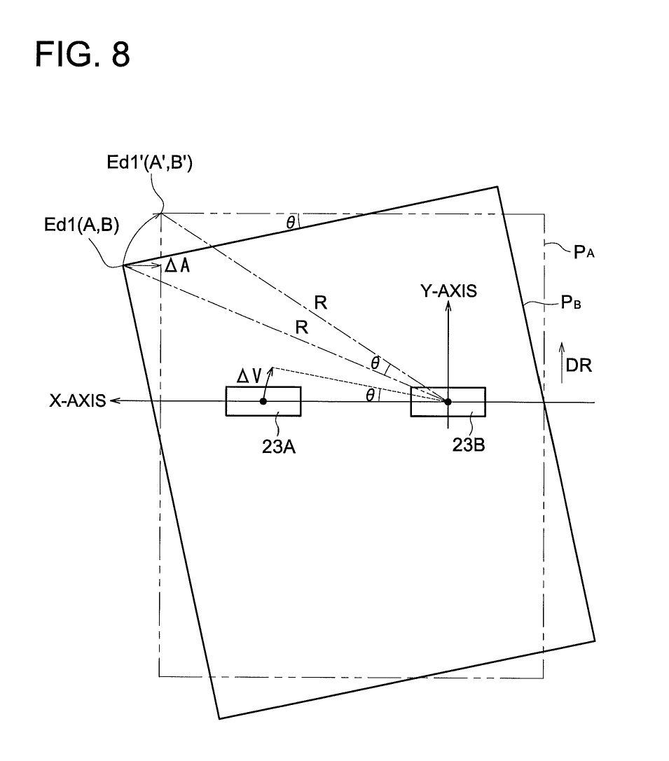

Next, referring to FIG. 8, an example of a method is described in which the control section 15 calculates speeds V1 and V2 of the first pair of rollers 23A and the second pair of rollers 23B respectively, and a timing T to start controlling a speed difference. In this example, a case will be described where a sheet is skewed in a counterclockwise direction, and the center of the second pair of rollers is set to a center of rotation.

The speed difference between the first pair of rollers 23A and the second pair of rollers 23B, that is ΔV=V1−V2, corresponds to a shift distance of one end of a line segment when a line segment between a center of the second pair of rollers 23B and a center of the first pair of rollers 23A is rotated clockwise by an angle θ with an end of the line segment on the side of the second pair of rollers 23B being a center of the rotation. The angle θ is equal to the skew angle θ detected by the first detection section 23M.

The coordinates (A′, B′) of the corner part Ed1 of the sheet P_{A} after it is rotationally shifted can be obtained by Formulae (1) and (2), provided that the coordinates (X, Y) of the corner part Ed1 of the sheet P_{B} before it is rotationally shifted is set to be (X, Y)=(A, B), wherein, the distance R in Formulae (1) and (2) is a distance between the center of the second pair of rollers 23B, the center of which is the rotation center of the sheet, and the corner part Ed1, and is a function of the speed V1, the speed V2, and the timing T.

A′=R(A cos θ−B sin θ) (1)

B′=R(B cos θ+A sin θ) (2)

R=F(V1, V2, T)

The amount of the bias ΔA detected by the first detection section 23M is given by Formula (3).

$$\begin{matrix}Δ A = {A}^{′} - A \\ = F ( V 1 , V 2 , T ) \times \{ ( A cos θ - 1 ) - B sin θ \}\end{matrix} \qquad ( 3 )$$

By determining F(V1, V2, T) from a table, an equation, or experimental values, the control section 15 calculates the speed V1 of the first pair of rollers 23A, the speed V2 of the second pair of rollers 23B, and the timing T to start controlling the speed difference.

As described above, the effect below will be obtained according to an embodiment of the present invention.

Since the first drive section Ma and the second drive section Mb independently drive each of the first pair of rollers 23A and the second pair of rollers 23B, the control section 15 can individually control the rotating speeds of the first pair of rollers 23A and the second pair of rollers 23B. By making the rotating speed differ between the first pair of rollers 23A and the second pair of rollers 23B during the above pairs of rollers nip the sheet P, the first pair of rollers 23A and the second pair of rollers 23B can change the orientation of the sheet at the same time while conveying the sheet P. Consequently, the control section 15 can control the orientation of the sheet P to the predetermined reference orientation by making rotating speed difference between the first pair of rollers 23A and the second pair of rollers 23B based on the skew angle of the sheet P detected by the first detection section 23M.

If the timing of the control section 15 to change the rotating speed is relatively early, the rear part of the sheet P is largely displaced in a direction perpendicular to the conveying direction DR. On the other hand, if the timing of the control section 15 to change the rotating speed is relatively late, the front part of the sheet P is largely displaced in a direction perpendicular to the conveying direction DR. Consequently, by controlling a timing to change the rotating speed based on a location of the corner part Ed1 of the sheet P detected by the first detection section 23M, it is possible for the control section 15 to shift the location of the corner part Ed1 of the sheet P to the predetermined target position.

Further, since it will do well only if the first drive section Ma and the second drive section Mb are provided with a mechanism which individually drives the first pair of rollers 23A and the second pair of rollers 23B, an orientation and a position of an edge part of the sheet P can be adjusted by a relatively simple mechanism.

Therefore, according to an embodiment of the present invention, there can be provided the color copier 100 provided with the conveyance section 20 which can correct a skewed sheet conveyance and a positional bias of the sheet P by means of simple mechanisms.

The second detection section 21A detects a position of the corner part Ed1 of the sheet P in a direction perpendicular to the conveying direction DR before a skew angle and a position of the corner part Ed1 is detected by the first detection section 23M. The control section 15 controls a timing to change rotating speed by setting the corner part Ed1 detected by the second detection section 21A to be a target position. With this method, since the control section 15 can adjust a position of the corner part Ed1 of the sheet P to the position of the corner edge Ed1 of the sheet P detected by the second detection section 21A, it is possible to set a target position for each of the sheets P when correcting a positional bias of the sheet P.

As described above, though the present invention was described with one embodiment, it should not be understood that the invention is limited by the description and drawings, which constitute a part of this disclosure. Various alternative embodiments, examples, and implementation technologies will become apparent from this disclosure to those skilled in the art.

For example, in the embodiment, the corner part Ed1 of the sheet P was taken and illustrated as an position of an edge part of the sheet P in the direction perpendicular to the conveying direction DR detected by each of the first detection section 23M and the second detection section 21A, but the edge part is not limited to it. It can be a position of other corner parts Ed2 to Ed4, the side Ln2 of the sheet P connecting the corner part Ed1 and the corner part Ed4, or the side of the sheet P connecting the corner part Ed2 and the corner part Ed3.

Further, as the second detection section, the second detection section 21A was described, but the present invention is not limited to it. When an image is formed on the reverse side of the sheet P, the second detection section 21B, in place of the second detection section 21A, can be used to correct a positional bias of the sheet P.

In the embodiment, there was described a case where the control section 15 controls a timing to change rotating speed, with a position of an edge part of the sheet P detected by the second detection section 21A being a target position, but the present invention is not limited to it. For example, the control section 15 can control a timing to change rotating speed with a predetermined position being a target position. In this case, as a constitution of the conveyance section 20, the second detection sections 21A and 21B become unnecessary. With the constitution, since the control section 15 can adjust a position of an edge part of the sheet P to a predetermined position, it becomes possible to standardize the position of the edge part of the sheet P after a positional bias has been corrected.

Further, in the embodiment of the present invention, there was described a case where the sheet conveying apparatus of the present invention was applied to the conveyance section 20 which conveys the sheet P from a paper feed tray to a fixing apparatus, it is possible to apply the above apparatus to the ADF 40 which conveys the document 30 of the color copier 100. The sheet conveying apparatus can be applied to a mechanism which conveys sheets including the sheet P and the document 30.

Further, in the embodiment of the present invention, though the color copier 100, provided with a sheet conveying apparatus, was described, a sheet conveying apparatus according to an embodiment of the present invention can be applied not only to the color copier 100, but also to an apparatus in which an image is formed on a sheet, or a reading apparatus in which an image printed on a document is read, such as a black and white copier, a printer, and a facsimile.

As such, it should be understood that the present invention includes various embodiments which are not described here. Therefore, the present invention should be limited by specific items of the invention according to the claims which are reasonable from the disclosure.

According to the sheet conveying apparatus and the image forming apparatus of the present invention, a skewed sheet conveyance and a positional bias of a sheet can be corrected with simple mechanisms.

What is claimed is:

1. A sheet conveying apparatus comprising:
a first pair of rollers and a second pair of rollers which are provided in a same axis perpendicular to a fixed direction and which convey a sheet in the fixed direction by rotating while nipping the sheet;
a first drive section which drives the first pair of rollers;
a second drive section which drives the second pair of rollers;
a first detection section which detects a skew angle of the sheet being conveyed, with respect to the fixed direction and a position of an edge part of the sheet in a direction perpendicular to the fixed direction before the sheet reaches the first pair of rollers and the second pair of rollers; and
a control section which changes at least one of rotating speeds of the first pair of rollers and the second pair of rollers based on the skew angle detected by the first detection section and which controls timing of making the rotating speeds of the first pair of rollers and the second pair of rollers differ from each other based on the position of the edge part detected by the first detection section.

2. The sheet conveying apparatus of claim 1, further comprising:
a second detection section which detects, before the first detection section detects the skew angle and the position of the edge part, a position of an edge part of the sheet in the direction perpendicular to the fixed direction,
wherein the control section controls timing of changing at least one of rotating speeds of the first pair of rollers and the second pair of rollers regarding the position of the edge part detected by the second detection section as a target position.

3. The sheet conveying apparatus of claim 1,
wherein the control section controls timing of changing at least one of rotating speeds of the first pair of rollers and the second pair of rollers regarding a predetermined position as a target position.

4. An image forming apparatus comprising:
an image forming section for forming an image on a sheet; and
a sheet conveying apparatus for conveying the sheet, the sheet conveying apparatus comprising:
a first pair of rollers and a second pair of rollers which are provided in a same axis perpendicular to a fixed direction and which convey the sheet in the fixed direction by rotating while nipping the sheet;
a first drive section which drives the first pair of rollers;
a second drive section which drives the second pair of rollers;
a first detection section which detects a skew angle of the sheet, with respect to the fixed direction and a position of an edge part of the sheet in a direction perpendicular to the fixed direction before the sheet is conveyed by the first pair of rollers and the second pair of rollers; and
a control section which changes at least one of rotating speeds of the first pair of rollers and the second pair of rollers based on the skew angle detected by the first detection section and which controls timing of making the rotating speeds of the first pair of rollers and the second pair of rollers differ from each other based on the position of the edge part detected by the first detection section.

5. The image forming apparatus of claim 4, further comprising:
a second detection section which detects, before the first detection section detects the skew angle and the position of the edge part, a position of an edge part of the sheet in the direction perpendicular to the fixed direction,
wherein the control section controls timing of changing at least one of rotating speeds of the first pair of rollers and the second pair of rollers regarding the position of the edge part detected by the second detection section as a target position.

6. The image forming apparatus of claim 4,
wherein the control section controls timing of changing at least one of rotating speeds of the first pair of rollers and the second pair of rollers regarding a predetermined position as a target position.
